(19) United States
(12) Patent Application Publication
(10) Pub. No.: US 2015/0312082 A1
(43) Pub. Date: Oct. 29, 2015

(54) METHOD AND APPARATUS FOR GENERATING CONTROL INFORMATION IN WIRELESS COMMUNICATION SYSTEM

(71) Applicant: Samsung Electronics Co., Ltd., Suwon-si (KR)

(72) Inventors: Cheol-Kyu SHIN, Suwon-si (KR); Young-Bum KIM, Seoul (KR); Hyo-Jin LEE, Suwon-si (KR)

(21) Appl. No.: 14/699,375

(22) Filed: Apr. 29, 2015

(30) Foreign Application Priority Data
Apr. 29, 2014 (KR) 10-2014-0051788
May 9, 2014 (KR) 10-2014-0055586

(51) Int. Cl. H04L 27/36; H04W 76/04; H04L 1/00

(52) U.S. Cl. CPC H04L 27/362; H04L 1/0009; H04L 1/0003; H04W 76/046

(57) ABSTRACT

A method for generating control information by a terminal in a wireless communication system is provided. The method includes determining whether the terminal supports a high-order modulation scheme, and if the terminal supports the high-order modulation scheme, feeding back control information for supporting the high-order modulation scheme to a base station. The control information includes a first Channel Quality Indicator (CQI) table for supporting the high-order modulation scheme, and the first CQI table is generated by removing a plurality of CQI entries from a second CQI table including a low-order modulation scheme, and replacing a last CQI table index as the high-order modulation scheme.

### CROSS-REFERENCE TO RELATED APPLICATION(S)

This application claims the benefit under 35 U.S.C. §119(a) of a Korean patent application filed on Apr. 29, 2014, in the Korean Intellectual Property Office and assigned Serial number 10-2014-0051788, and of a Korean patent application filed on May 9, 2014 in the Korean Intellectual Property Office and assigned Serial number 10-2014-0055586, the entire disclosures of each of which are hereby incorporated by reference.

### TECHNICAL FIELD

The present disclosure relates to a method and apparatus for generating control information in a wireless communication system.

### BACKGROUND

The demand for wireless data traffic is on the rise since the commercialization of the 4^{th} Generation (4G) communication system. In order to satisfy this demand, efforts have been made to develop an improved 5^{th} Generation (5G) communication system or a pre-5G communication system. For this reason, the 5G communication system or pre-5G communication system is sometimes referred to as a Beyond 4G Network communication system or a Post Long Term Evolution (LTE) system. In order to achieve a high data transfer rate, the 5G communication system may be considered to be implemented in a millimeter wave (mmWave) band (e.g., a 60 GHz band, etc.). In order to ease the path loss of the radio wave and increase the reach of the radio wave in the millimeter wave band, technologies such as beamforming, massive Multiple Input Multiple Output (MIMO), Full Dimensional MIMO (FD-MIMO), array antenna, analog beamforming, and large scale antenna have been discussed for the 5G communication system. Further, in order to improve the network of the system, technologies such as evolved small cell, advanced small cell, cloud Radio Access Network (cloud RAN), ultra-dense network, Device to Device communication (D2D), wireless backhaul, moving network, cooperative communication, Coordinated Multi-Points (CoMP), and received interference cancellation have been developed for the 5G communication system. In addition, an Advanced Coding Modulation (ACM) scheme such as Hybrid FSK and Quadrature Amplitude Modulation (QAM) and Sliding Window Superposition Coding (SWSC), and an advanced access technology such as Filter Bank Multi Carrier (FBMC), Non Orthogonal Multiple Access (NOMA), and Sparse Code Multiple Access (SCMA) have been developed for the 5G communication system.

On the other hand, the Internet has evolved from the human-centered connection network in which the humans generate and consume information, into the Internet of Things (IoT) network in which distributed components such as things exchange information with each other to process the information. Even Internet of Everything (IoE) technology has emerged, in which Big Data processing technology and the like is combined with the IoT technology through the connection with a cloud server and the like. In order to implement the IoT, technical components such as sensing technology, wired/wireless communication and network infrastructure, service interface technology and security technology are required, and in recent years, technologies such as sensor network for connection between things, Machine to Machine (M2M), and Machine Type Communication (MTC) have been developed. In the IoT environment, an intelligent Internet Technology (IT) service may be provided to create a new benefit for people by collecting and analyzing the data generated in the connected things. IoT may be used in various fields such as Smart Home, Smart Building, Smart City, Smart Car (or Connected Car), Smart Grid, Healthcare, Smart Appliances, and Advanced Media Service through the convergence and integration between the existing Information Technology (IT) technology and various industries.

Accordingly, various attempts have been made to apply the 5G communication system to the IoT network. For example, the technologies such as sensor network, M2M and MTC may be implemented by 5G communication technology such as beamforming, MIMO and array antenna. Applying the cloud RAN as the above-described Big Data processing technology may be an example of the convergence of the 5G technology and the IoT technology.

FIG. 1 illustrates a basic structure of a time-frequency domain that is a radio resource domain where data or control information is transmitted in a downlink in an LTE system according to the related art.

Referring to FIG. 1, the vertical axis represents the time domain and the horizontal axis represents the frequency domain. The minimum transmission unit in the time domain may be an Orthogonal Frequency Division Multiplexing (OFDM) symbol. N_{symb} OFDM symbols 102 may constitute one slot 106, and two slots may constitute one subframe 105. A length of the slot may be 0.5 ms, and a length of the subframe may be 1.0 ms. The minimum transmission unit in the frequency domain may be a subcarrier.

In the time-frequency domain, the basic unit of resource may be a Resource Element (RE) 112, which can be represented by an OFDM symbol index and a subcarrier index. A Resource Block (RB) 108 or a Physical Resource Block (PRB) may be defined as N_{symb} consecutive OFDM symbols 102 in the time domain and N^{RB}_{SC} consecutive subcarriers 110 in the frequency domain. Therefore, one RB 108 may include N_{symb}×N^{RB}_{SC} REs 112. Generally, the minimum transmission unit of data may be the RB, and the system transmission band may include a total of N_{RB} RBs. In addition, the entire system transmission band may include a total of N_{RB}×N^{RB}_{SC} subcarriers 104. Generally, in the LTE system, N_{symb}=7 and N^{RB}_{SC}=12.

Control information may be transmitted on the first N or fewer OFDM symbols in the subframe. Generally, a control channel transmission period N may be N={1, 2, 3}. Therefore, the value of N may be changed in each subframe depending on the amount of control information that should be transmitted in the current subframe. The control information may include an indicator indicating the number of OFDM symbols over which the control information is transmitted, scheduling information for uplink (UL) or downlink (DL) data, Hybrid Automatic Repeat reQuest (HARQ) ACK/NACK signal, and the like.

The LTE system may employ the HARQ scheme in which a physical layer retransmits the data if a decoding failure occurs in the initial transmission. In the HARQ scheme, if a receiver fails to decode data correctly, the receiver may transmit information (e.g., NACK) indicating the decoding failure to a transmitter, so the transmitter may retransmit the data in its physical layer. The receiver may combine the data retransmitted by the transmitter with the existing data that the receiver has failed to decode, to increase the data reception performance. On the other hand, if the receiver has decoded data correctly, the receiver may transmit information (e.g., ACK) indicating the decoding success to the transmitter, so the transmitter may transmit new data.

In a broadband wireless communication system, one of the important things to provide a high-speed wireless data service may be support of a scalable bandwidth. As an example, the system transmission band of the LTE system may have various bandwidths such as 20, 15, 10, 5, 3, and 1.4 MHz. Therefore, service providers may provide a service by selecting a particular bandwidth from among the various bandwidths. In addition, there may be various types of terminals, including a terminal capable of supporting a maximum of a 20 MHz bandwidth and a terminal capable of supporting a minimum of a 1.4 MHz bandwidth.

In the LTE system, scheduling information for uplink or downlink data may be provided by a base station to a terminal through Downlink Control Information (DCI). The uplink means a wireless link via which a terminal transmits data or a control signal to a base station, and the downlink means a wireless link via which a base station transmits data or a control signal to a terminal. For the DCI, several formats may be defined, and a predetermined DCI format may be applied depending on whether the scheduling information is scheduling information (e.g., a UL grant) for uplink data or scheduling information (e.g., a DL grant) for downlink data, whether the size of the control information is a small (compact DCI), whether spatial multiplexing based on multiple antennas is applied, and whether the DCI is a DCI for power control. For example, DCI format 1, which is scheduling control information (e.g., a DL grant) for downlink data, may be configured to include the following control information.

Resource allocation type 0/1 flag: Resource allocation type 0/1 flag notifies whether the resource allocation scheme is type 0 or type 1. A Type-0 flag is to allocate resources in units of Resource Block Group (RBG) by applying a bitmap scheme. In the LTE system, the basic unit of scheduling may be a Resource Block (RB) that is expressed by time-frequency domain resources, and the RBG may include multiple RBs and may be the basic unit of scheduling in the Type-0 scheme. A Type-1 flag is to allocate a particular RB in an RBG.

Resource block assignment: Resource block assignment notifies an RB allocated for data transmission. The resources may be determined depending on the system bandwidth and the resource allocation scheme.

Modulation and Coding Scheme (MCS): MCS notifies a modulation scheme used for data transmission and a size of a transport block to be transmitted.

HARQ process number: HARQ process number notifies a process number of HARQ.

New data indicator: New data indicator notifies whether the HARQ transmission is an initial transmission or a retransmission.

Redundancy version: Redundancy version notifies a redundancy version of HARQ.

TPC command for PUCCH: Transmit Power Control (TPC) command for Physical Uplink Control Channel (PUCCH) notifies a power control command for a PUCCH that is an uplink control channel.

The DCI may be transmitted over a Physical Downlink Control Channel (PDCCH) after undergoing a channel coding and modulation process.

Generally, the DCI may undergo channel coding for each terminal independently, and then, the channel-coded DCI may be configured with its dependent PDCCH and transmitted. In the time domain, a PDCCH may be mapped and transmitted during the control channel transmission period. The frequency-domain mapping location of the PDCCH may be determined by an ID of each terminal, and may be spread throughout the entire system transmission band.

Downlink data may be transmitted over a Physical Downlink Shared Channel (PDSCH) that is a physical channel for downlink data transmission. A PDSCH may be transmitted since the control channel transmission period, and the scheduling information such as the detailed mapping location in the frequency domain and the modulation scheme may be notified by the DCI that is transmitted over the PDCCH.

Using a 5-bit Modulation and Coding Scheme (MCS) in the control information constituting the DCI, the base station may notify the terminal of the modulation scheme applied to the PDSCH to be transmitted and the size (e.g., a Transport Block Size (TBS)) of the data to be transmitted. The TBS may correspond to the size given before channel coding for error correction is applied to the data to be transmitted by the base station.

Generally, the modulation scheme supported by the LTE system may include Quadrature Phase Shift Keying (QPSK), 16-ary QAM, 64QAM and the like. However, a Channel Quality Indicator (CQI) and MCS table generation method supporting 256QAM has not been defined for the LTE system.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for generating Channel Quality Indicator (CQI) and Modulation and Coding Scheme (MCS) tables in a communication system supporting 256 Quadrature Amplitude Modulation (QAM).

In accordance with an aspect of the present disclosure, a method for generating control information by a terminal in a wireless communication system is provided. The method includes determining whether the terminal supports a high-order modulation scheme, and if the terminal supports the high-order modulation scheme, feeding back control information for supporting the high-order modulation scheme to a base station. The control information includes a first CQI table for supporting the high-order modulation scheme. The first CQI table is generated by removing a plurality of CQI entries from a second CQI table including a low-order modulation scheme and replacing a last CQI table index as the high-order modulation scheme.

In accordance with another aspect of the present disclosure, a method for generating control information by a base station in a wireless communication system is provided. The method includes determining a first MCS table based on a channel status. The first MCS table is generated by removing a plurality of MCS entries related to a low-order modulation scheme from a second MCS table and setting a last MCS table index as a retransmission mode for a high-order modulation scheme.

In accordance with another aspect of the present disclosure, an apparatus for generating control information in a terminal for a wireless communication system is provided. The apparatus includes a controller configured to determine whether the terminal supports a high-order modulation scheme, and if the terminal supports the high-order modulation scheme, to feed back control information for supporting the high-order modulation scheme to a base station. The control information includes a first CQI table for supporting the high-order modulation scheme. The first CQI table is generated by removing a plurality of CQI entries from a second CQI table including a low-order modulation scheme and replacing a last CQI table index as the high-order modulation scheme.

In accordance with another aspect of the present disclosure, an apparatus for generating control information in a base station for a wireless communication system is provided. The apparatus includes a controller configured to determine a first MCS table based on a channel status. The first MCS table is generated by removing a plurality of MCS entries related to a low-order modulation scheme from a second MCS table and setting a last MCS table index as a retransmission mode for a high-order modulation scheme.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a basic structure of a time-frequency domain in a Long Term Evolution (LTE) system according to the related art;

FIG. 2 is a table illustrating a modulation scheme and a Transport Block Size (TBS) index corresponding to a Modulation and Coding Scheme (MCS) in an LTE system according to an embodiment of the present disclosure;

FIGS. 3, 4, 5, 6, 7, 8, 9, 10, 11, 12, and 13 illustrate TBS tables defined in an LTE system according to various embodiments of the present disclosure;

FIGS. 14A, 14B, 14C, and 14D are constellations illustrating modulation methods available according to various embodiments of the present disclosure;

FIG. 15 illustrates how a terminal transmits Channel Quality Indicator (CQI), which is one of channel status information, depending on the signal energy and interference strength measured by the terminal according to an embodiment of the present disclosure;

FIGS. 16 and 17 illustrate CQI tables generated according to various embodiments of the present disclosure;

FIG. 18 is a graph illustrating a theoretical capacity curve according to an embodiment of the present disclosure;

FIG. 19 illustrates a CQI table that is obtained from FIG. 16 through the code rate determination method-1 according to an embodiment of the present disclosure;

FIG. 20 illustrates a CQI table that is obtained from FIG. 17 through the code rate determination method-1 according to an embodiment of the present disclosure;

FIG. 21 illustrates a CQI table that is obtained from FIG. 16 through the code rate determination method-2 according to an embodiment of the present disclosure;

FIG. 22 illustrates a CQI table that is obtained from FIG. 17 through the code rate determination method-2 according to an embodiment of the present disclosure;

FIGS. 23 and 24 illustrate MCS tables generated according to various embodiments of the present disclosure;

FIG. 25 is a flowchart illustrating how to use a CQI table according to an embodiment of the present disclosure;

FIG. 26 is a flowchart illustrating how to use an MCS table according to an embodiment of the present disclosure;

FIGS. 27A, 27B, 27C, 27D, and 28 illustrate experimental results using an MCS table generated according to various embodiments of the present disclosure;

FIG. 29 illustrates a structure of a terminal according to an embodiment of the present disclosure; and

FIG. 30 illustrates a structure of a base station according to an embodiment of the present disclosure.

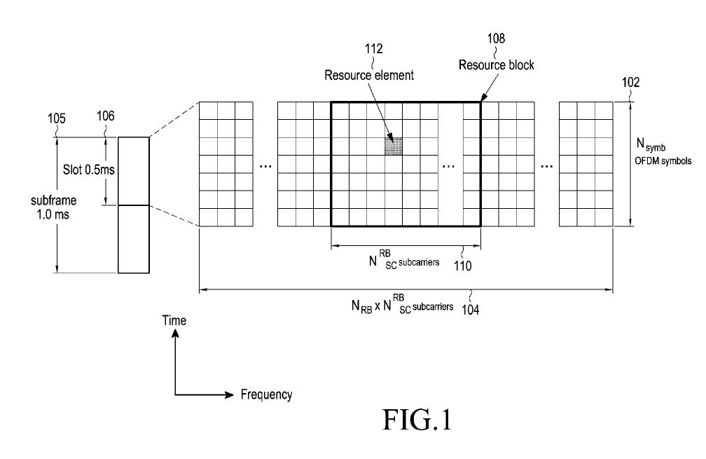

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In the following description, a Base Station (BS), which is an entity for performing resource allocation for a terminal, may be at least one of an evolved Node B (eNB), a Node B, a BS, a wireless access unit, a BS Controller (BSC), or a node on a network.

A terminal may include a User Equipment (UE), a Mobile Station (MS), a cellular phone, a smart phone, a computer, or a multimedia system with a communication function. Although specific embodiments of the present disclosure will be described in connection with, for example, an Evolved-Universal Terrestrial Radio Access (E-UTRA) (or Long Term Evolution (LTE)) system or an Advanced E-UTRA (or LTE-Advanced (LTE-A)) system, an embodiment of the present disclosure may be applied to any other communication systems having the similar technical backgrounds and/or channel formats. In addition, it will be apparent to those of ordinary skill in the art that an embodiment of the present disclosure may be applied to other communication systems with some modifications without departing from the scope of the present disclosure.

The modulation scheme supported by the LTE system may include Quadrature Phase Shift Keying (QPSK), 16-ary Quadrature Amplitude Modulation (QAM), and 64QAM, a modulation order of which corresponds to (Qₘ)={2, 4, 6}, respectively. In other words, it is possible to transmit 2 bits per QPSK modulation symbol, 4 bits per 16QAM modulation symbol, and 6 bits per 64QAM modulation symbol.

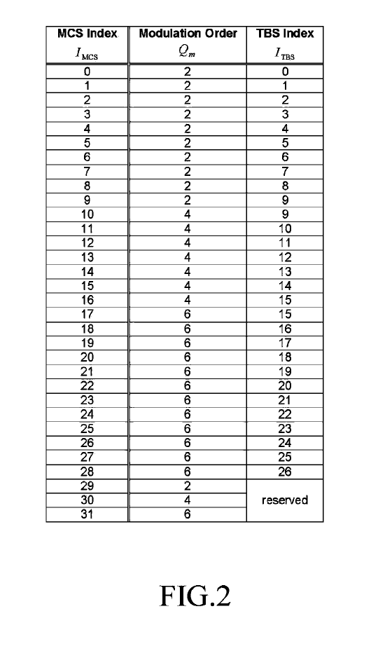

FIG. 2 is a table illustrating a modulation scheme and a Transport Block Size (TBS) index corresponding to a Modulation and Coding Scheme (MCS) in an LTE system according to an embodiment of the present disclosure.

For example, if MCS is 10 (I_{MCS}=10), it indicates that the modulation scheme is 16QAM and the TBS index I_{TBS} is 9. The size (e.g., TBS) of downlink data transmitted to a terminal may be determined by the number N_{PRB} of Resource Blocks (RBs) allocated to the terminal and the TBS index I_{BS}.

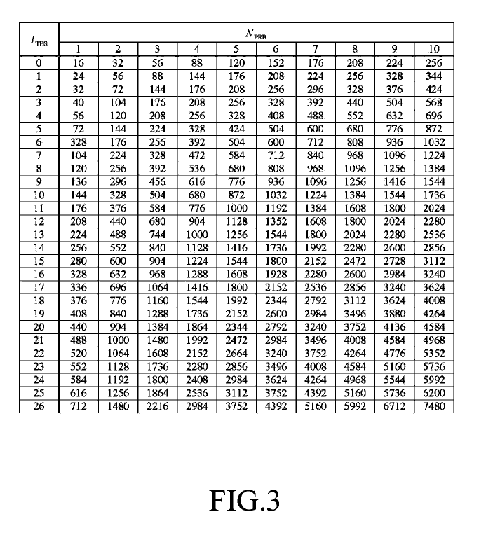

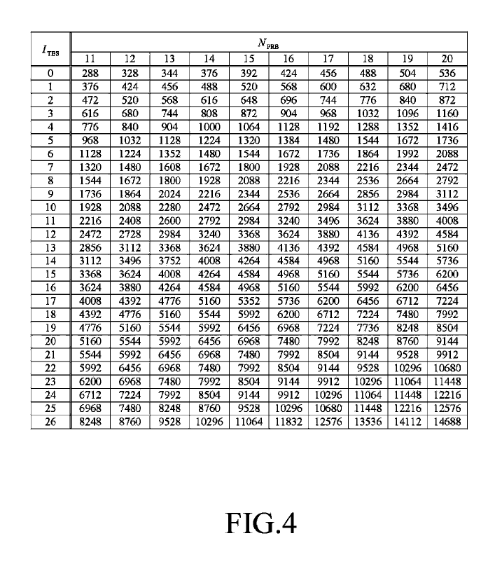

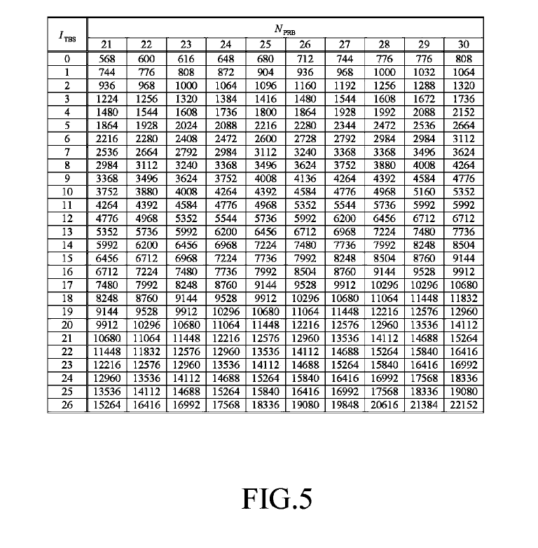

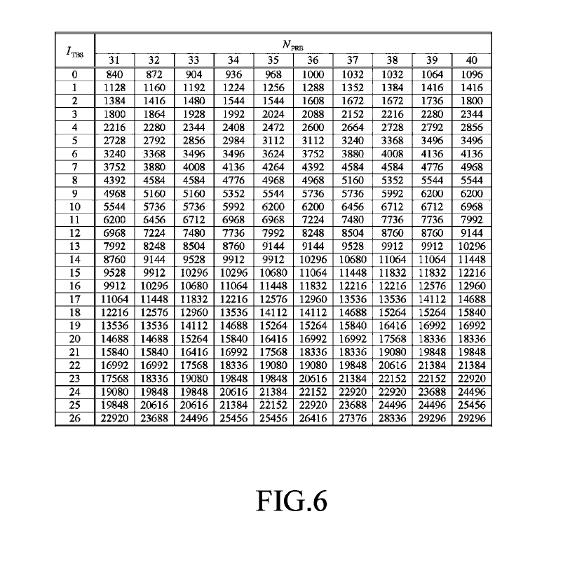

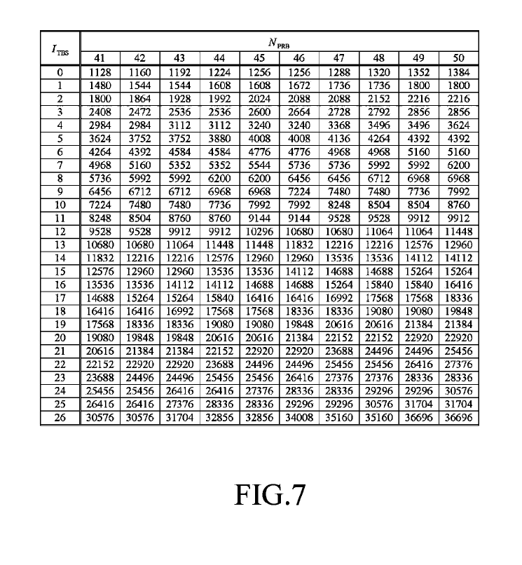

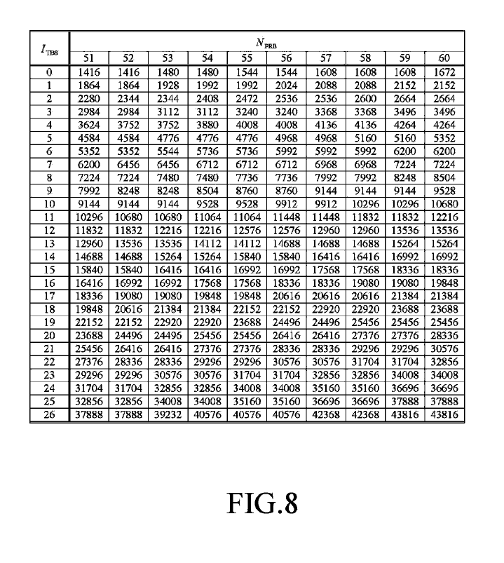

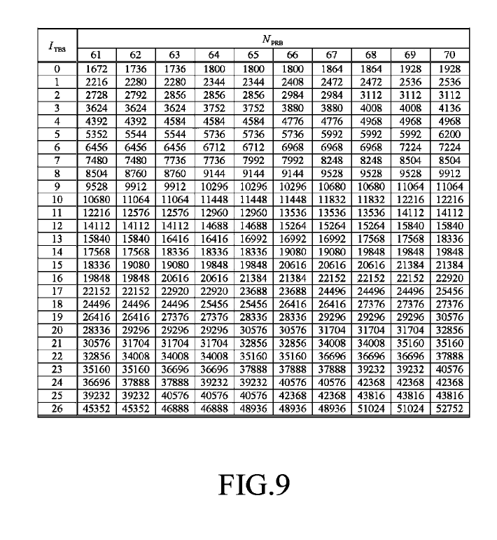

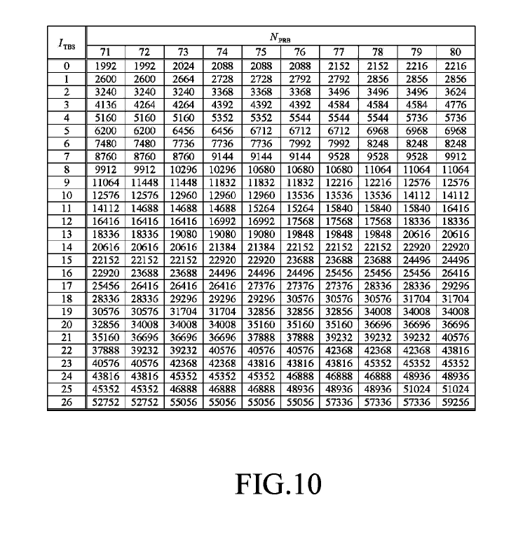

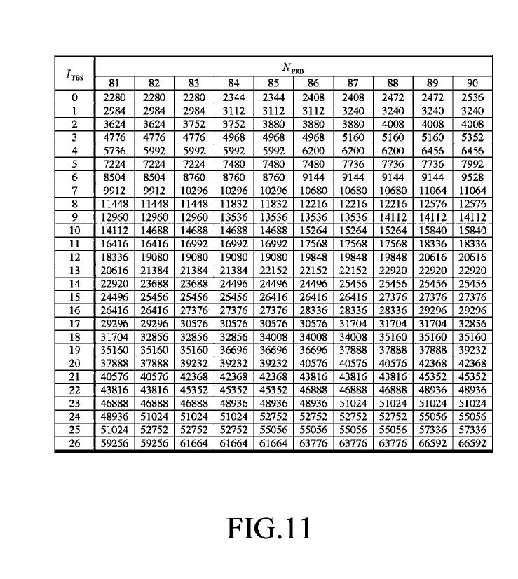

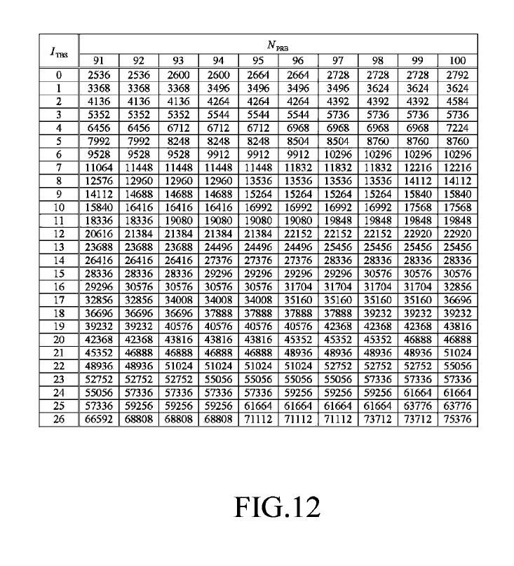

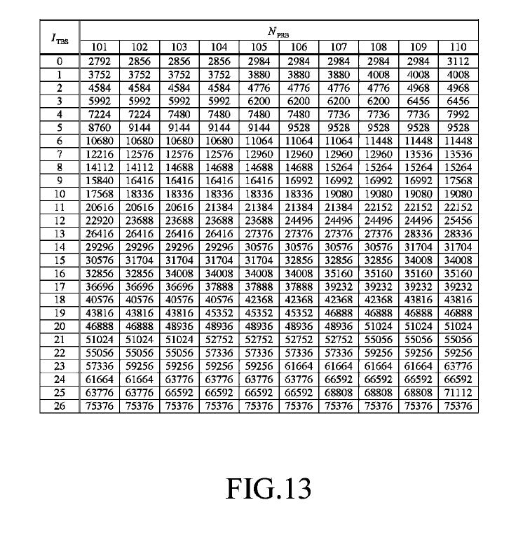

FIGS. 3, 4, 5, 6, 7, 8, 9, 10, 11, 12, and 13 illustrate TBS tables defined in an LTE system according to various embodiments of the present disclosure.

Specifically, FIGS. 3 to 13 illustrate TBSs corresponding to TBS indexes I_{TBS} for N_{PRB}=1 to N_{PRB}=110.

For example, if the BS notifies ‘N_{PRB}=10’ to the terminal using ‘Resource block assignment’ control information constituting the DCI, and notifies ‘I_{MCS}=10’ to the terminal using the MCS, it indicates that the TBS index I_{TBS} is 9 in FIG. 2 and the TBS is 1544 in FIG. 3.

To increase the transmission efficiency of the LTE system, the introduction of a high-order modulation scheme such as 256QAM has been considered.

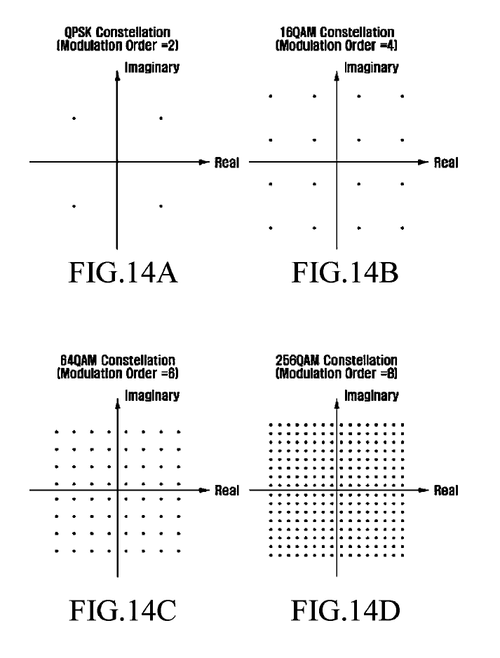

FIGS. 14A, 14B, 14C, and 14D illustrate modulation methods according to various embodiments of the present disclosure.

It is possible to consider using 256QAM as shown in FIG. 14D, in addition to the modulation orders of 2, 4, and 6 used in the LTE system as shown in FIGS. 14A to 14C. 256QAM, a modulation order of which is 8, may transmit 8 bits per modulation symbol, so its transmission efficiency (discussed below) is higher than that of 64QAM by 33% or more.

In a mobile communication system, it is necessary to transmit a reference signal in order to measure a downlink channel status. For example, in the case of the 3^{rd} Generation Partnership Project (3GPP) LTE-A system, a terminal may measure a channel status between a BS and the terminal itself, using a Channel Status Information Reference Signal (CSI-RS) transmitted by the BS. For the channel status, several factors should be considered by default, and may include interference in a downlink. The interference in a downlink may include an interference signal, thermal noise and the like, which are generated by an antenna of an adjacent BS, and the interference in a downlink may be important in determining the channel condition of the downlink by the terminal. For example, if a BS with one transmit antenna transmits a reference signal to a terminal with one receive antenna, the terminal should determine a parameter Es/Io indicating the received signal strength by determining the energy per symbol that can be received via a downlink and the interference that is to be received at the same time in the interval where the symbol is received, based on the reference signal received from the BS. The determined Es/Io may be notified to the BS, allowing the BS to determine at which data transfer rate the BS will perform downlink transmission to the terminal.

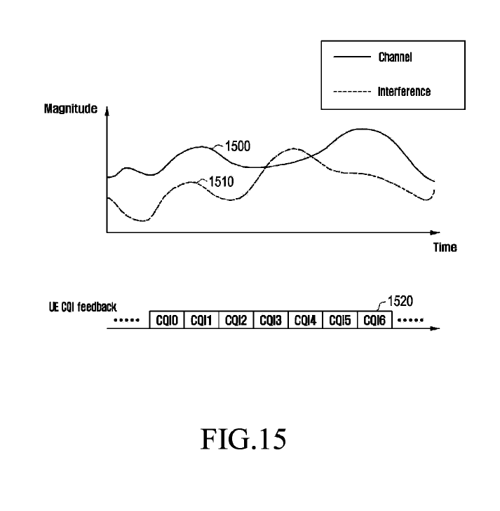

FIG. 15 illustrates how a terminal transmits CQI, which is one of channel status information, depending on the signal energy and interference strength measured by the terminal according to an embodiment of the present disclosure.

Referring to FIG. 15, a terminal may perform channel estimation by measuring a downlink reference signal such as CSI-RS, and calculate the received signal energy Es for a wireless channel using the channel estimate as shown by reference numeral 1500. In addition, the terminal may calculate the intensity Io of interference and noise using the downlink reference signal or the separate resource for interference or noise measurement, as shown by reference numeral 1510. In the LTE system, a Cell-specific Reference Signal (CRS) that is a downlink reference signal may be used for interference and noise measurement, or the BS may configure an interference measurement resource for the terminal so that the terminal may assume the signal measured in the wireless resource as interference and noise. Using the received signal energy Es and the intensity Io of interference and noise, which are obtained in this way, the terminal may determine the maximum data transfer rate that the terminal can receive data with a predetermined success rate at the signal to interference and noise ratio calculated by the terminal itself, and then notify the determined maximum data transfer rate to the BS. Upon receiving a notification of the maximum data transfer rate that the terminal can support at the calculated signal to interference and noise ratio, the BS may determine the actual data transfer rate for a downlink data signal that the BS will transmit to the terminal at the maximum data transfer rate. The maximum data transfer rate that the terminal has notified to the BS and at which the terminal can receive data with a predetermined success rate will be referred to as CQI in the LTE standard. Since a wireless channel is generally changed over time, the terminal may periodically notify the CQI to the BS as shown by reference numeral 1520, or may report the CQI each time the BS requests CQI from the terminal. The BS may request CQI from the terminal in at least one of a periodic way and an aperiodic way.

A detailed CQI and MCS table generation method for supporting 256QAM according to an embodiment of the present disclosure will be described in detail.

In a first embodiment of the present disclosure, a CQI table generation method to which high-order modulation such as 256QAM is applied is provided.

In a second embodiment of the present disclosure, an MCS table generation method to which high-order modulation such as 256QAM is applied is provided.

With respect to 256QAM support according to the first embodiment of the present disclosure, the CQI table generation method may be as follows:
In order to prevent an undesired increase of signaling overhead, the amount of CQI information may be maintained at 4 bits as in the prior art.
CQI index #0 may be maintained as out-of-range.
In order to newly define 256QAM in the CQI table, 3 CQI entries corresponding to QPSK may be removed from the existing CQI table.
In order to newly define 256QAM in the CQI table, the last CQI table index #15 may be replaced as 256QAM in the existing CQI table.
A CQI table index including 256QAM may be rearranged according to the spectral efficiency.

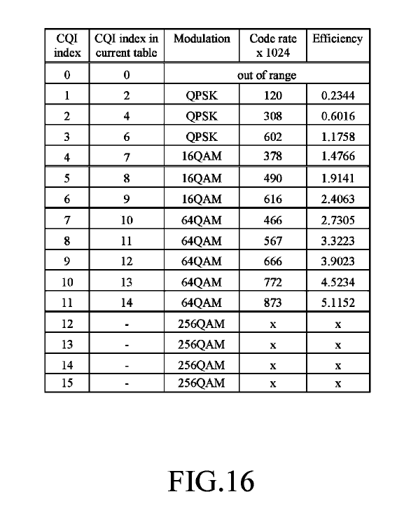

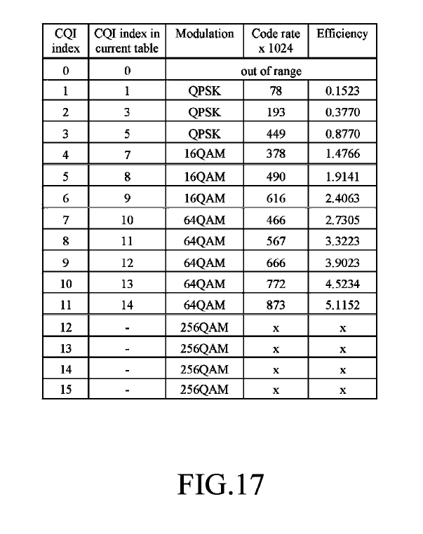

Therefore, the CQI table that can be considered based on the CQI table generation method may be as shown in FIG. 16 or 17.

FIGS. 16 and 17 illustrate CQI tables generated according to the first embodiment of the present disclosure.

FIGS. 16 and 17 may be distinguished according to the method of removing three CQI entries corresponding to QPSK from the existing CQI table. As the method of removing three CQI entries corresponding to QPSK from the existing CQI table, a method of removing CQI entries every other CQI entry without removing consecutive CQI indexes may be advantageous in maintaining a uniform Signal to Noise Ratio (SNR) gap between CQI entries. Since the channel status information is generally determined by the SNR, maintaining the uniform SNR gap between entries in the CQI table may enable the terminal to select a CQI capable of maximizing the transmission efficiency and notify the selected CQI to the BS. Therefore, FIG. 16 represents a case of removing three CQI indexes {#1, #3, #5} corresponding to even numbers from the existing CQI table, and FIG. 17 represents a case of removing three CQI indexes {#2, #4, #6} corresponding to odd numbers from the existing CQI table. By removing 3 CQI entries corresponding to QPSK from the existing CQI table and replacing the last CQI table index #15 as 256QAM, four 256QAM entries may be added as shown in FIGS. 16 and 17. If a code rate corresponding to each 256QAM entry is determined, the efficiency value may be automatically calculated. Generally, the efficiency value may be obtained by multiplying a modulation factor (or a modulation order) by a code rate. For example, in the case of 256QAM, if a code rate is 0.5, an efficiency value may be 4 by multiplying the modulation factor of 8 by the code rate of 0.5. The code rates of the 256QAM entries newly added in FIGS. 16 and 17 and the method of determining the efficiency values calculated from the code rates will be described in detail below.

Next, with respect to 256QAM support according to the second embodiment of the present disclosure, the MCS table generation method may be as follows:
The amount of MCS information may be maintained at 5 bits as in the prior art.
7 explicit entries for 256QAM may be defined in the MCS table.
A total of 4 implicit entries may be defined in the MCS table, and they may be used as retransmission modes for QPSK, 16QAM, 64QAM and 256QAM, respectively.

Based on the above, a total of 8 MCS entries may be removed from the existing MCS table, for 256QAM support. Generally, it is preferable that the MCS table is designed to ensure the high transmission efficiency in the high-SNR region, and to ensure the good transmission efficiency in the flat or dispersive channel environment in both the mid- and low-SNR regions. Therefore, the method of determining the MCS entries to be removed from the existing MCS table will be described in detail below.

Based on the above discussion, a method of defining the CQI and MCS tables for supporting 256QAM will be proposed through specific embodiments of the present disclosure.

### First Embodiment of Present Disclosure

First, for the four 256QAM entries newly added in FIGS. 16 and 17, efficiency values E12 and E15 corresponding to CQI indexes #12 and #15 may be determined as follows:
E12: an efficiency value of 5.5547, which corresponds to the existing CQI table index #15, may be reused.
E15: an efficiency value of 7.4063 (=8×(948/1024)) may be determined based on the code rate that is used for the existing CQI table index #15.

However, the determination of the values for E12 and E15 will not be limited to the above method. For example, the efficiency value for E12 may be newly determined taking into account the SNR gap with 64QAM corresponding to the CQI table index #11 in FIG. 16 or 17. In addition, the efficiency value for E15 may be determined based on the limit value for the code rate. Generally, if the code rate has a value close to 1, there is no effect of channel coding, so the limit value for the code rate may be determined. For example, in the case of the LTE system, an efficiency value for E15 may be determined as 8×0.93=7.44 based on the limit value of 0.93 for the code rate.

In the present disclosure, a method of determining a code rate of a 256QAM entry will be considered in the state where an efficiency value E12 of a CQI index #12 and an efficiency value E15 of a CQI index #15 are determined in FIGS. 16 and 17:
Code rate determination method-1: an SNR value may be acquired using a theoretical capacity value.
Code rate determination method-2: efficiency values of CQI indexes #13 and #14 may be acquired with an intermediate value between E12 and E15.

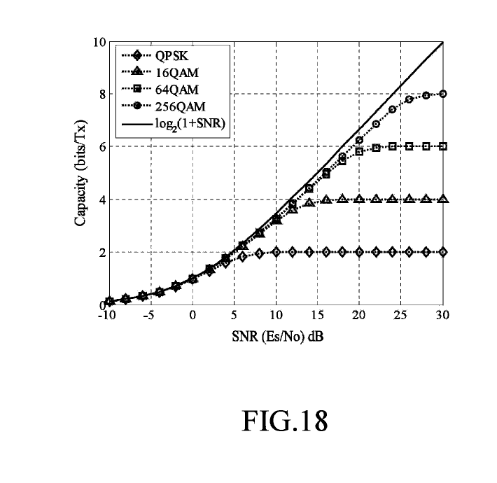

The code rate determination method-1 proposed in the present disclosure may be a method of finding a code rate having a uniform SNR gap using a theoretical capacity value. A theoretical capacity curve is illustrated in FIG. 18.

FIG. 18 is a graph illustrating a theoretical capacity curve according to an embodiment of the present disclosure.

Referring to FIG. 18, the solid line represents an ideal capacity value that can be obtained from a particular SNR without considering a particular modulation method. Other dotted lines represent capacity values that can be obtained from a particular SNR when modulation schemes of QPSK, 16QAM, 64QAM and 256QAM are used, respectively.

The code rate determination method-1 may determine a code rate from the capacity value in FIG. 18 for a case where a particular modulation scheme is used, under the assumption that the LTE system can approach the theoretical capacity in the Additive White Gaussian Noise (AWGN) environment using the Turbo code. For example, if an efficiency value E12 of the CQI index #12 is determined as 5.5547, it can be found that an SNR value from which the capacity of 5.5547 is acquired in FIG. 18 is 16.54 dB, from the capacity curve obtained when the 256QAM modulation scheme is used. After acquiring the SNR value satisfying the efficiency value for the CQI index #12, an efficiency value for the next CQI index #13 may be acquired using the theoretical capacity value by adding a predetermined SNR to the acquired SNR value. In the same way, it is possible to obtain efficiency values for the CQI indexes #14 and #15. In this case, the SNR gap may be adjusted such that the efficiency value for the CQI index #15 may not exceed a pre-considered E15. It is possible to calculate the code rate from the efficiency value of each 256QAM entry, which is determined through the code rate determination method-1.

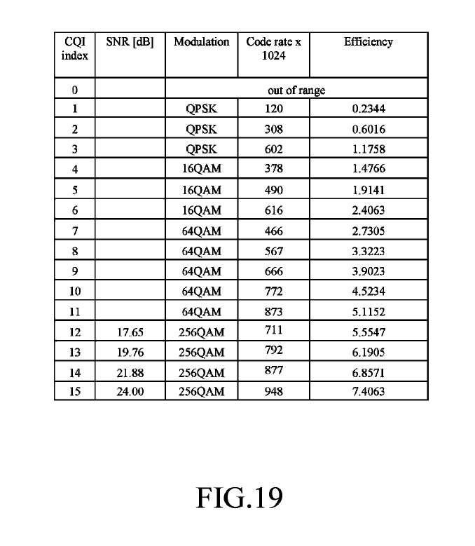

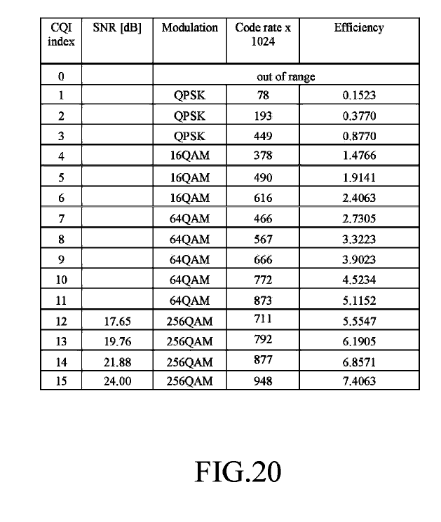

FIG. 19 illustrates a CQI table that is obtained from FIG. 16 through the code rate determination method-1 according to an embodiment of the present disclosure, and FIG. 20 illustrates a CQI table that is obtained from FIG. 17 through the code rate determination method-1 according to an embodiment of the present disclosure.

Referring to FIGS. 19 and 20, after values of E12 and E15 are determined as 5.5547 and 7.4063, respectively, the efficient values corresponding to the CQI table indexes #13 and #14 may be determined based on the uniform SNR gap of 2.1166 dB, using the capacity value of 256QAM in FIG. 18. However, as described above, the values of E12 and E15 may be set differently, and the code rates according thereto may be determined differently from FIGS. 19 and 20. In addition, the code rate determination method-1 may be obtained approximately from the ideal solid-line capacity curve instead of using the capacity curve corresponding to the modulation scheme in FIG. 18.

The code rate determination method-2 proposed in the present disclosure may be a method of acquiring efficiency values of the CQI indexes #13 and #14 from pre-set values of E12 and E15, using an intermediate value between them. This is based on the assumption that if an efficiency region is divided at equal intervals by reflecting the fact that the ideal solid-line capacity value increases linearly in the high-SNR region in FIG. 18, the SNR region may also be divided at equal intervals.

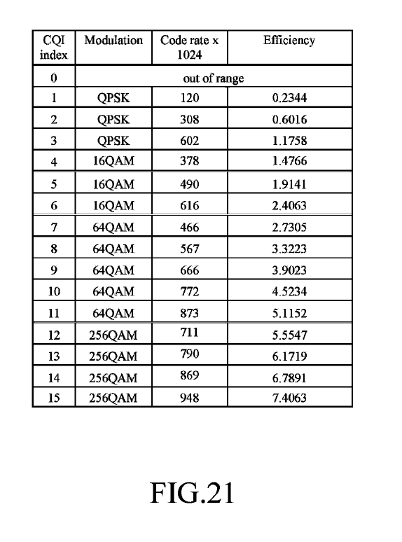

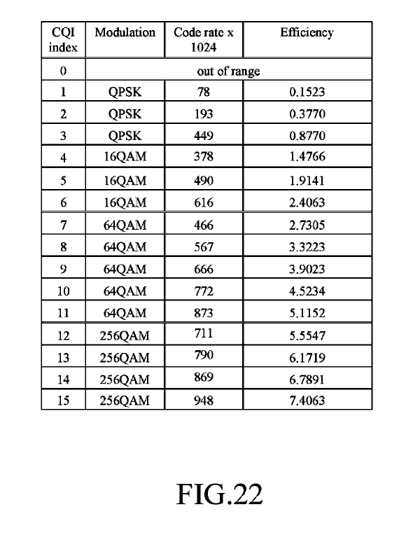

FIG. 21 illustrates a CQI table that is obtained from FIG. 16 through the code rate determination method-2 according to an embodiment of the present disclosure, and FIG. 22 illustrates a CQI table that is obtained from FIG. 17 through the code rate determination method-2 according to an embodiment of the present disclosure.

Noting the fact that a value of a code rate in FIG. 21 or 22 is not greatly different from a value of a code rate corresponding to 256QAM in FIG. 19 or 20, the code rate determination method-2 may have an advantage that it can determine a code rate value more easily without using the theoretical capacity value.

### Second Embodiment of Present Disclosure

The second embodiment of the present disclosure proposes an MCS table configuring method for 256QAM support.

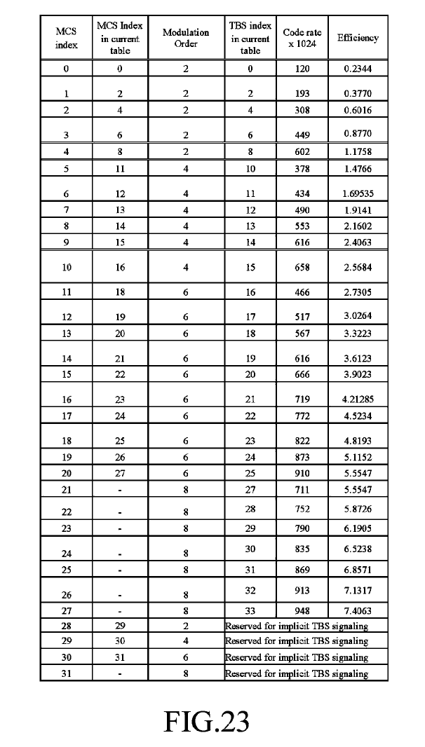

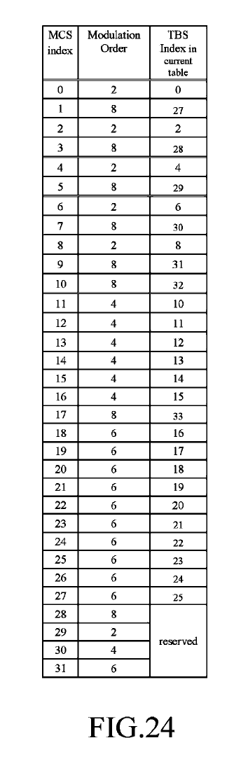

FIGS. 23 and 24 illustrate MCS tables generated according to various embodiments of the present disclosure.

The second embodiment of the present disclosure may include a method of determining a total of 8 MCS entries that are removed from the existing MCS table to add seven explicit entries and one implicit entry for 256QAM without changing the amount of 5-bit information of the existing MCS table.

First, seven explicit MCS entries may be determined with an intermediate value of the efficiency for four 256QAM entries and each entry defined in the CQI table. The specific method is illustrated in FIG. 23 based on the CQI tables in FIGS. 21 and 22.

Referring to FIG. 23, MCS indexes #21, #23, #25 and #27 represent four 256QAM entries defined in the CQI table, and MCS indexes #22, #24 and #26 are MCS indexes that are obtained with an intermediate value of the efficiency for each entry. In the second embodiment of the present disclosure, an MCS table is generated on the assumption of the CQI tables in FIGS. 21 and 22. However, assuming the CQI tables in FIGS. 19 and 20, which can be generated from the first embodiment of the present disclosure, the code rates and efficiency values for 256QAM, which are calculated in FIG. 23, may vary. Further, in FIG. 23, MCS #31 represents an implicit entry for a retransmission mode for 256QAM.

Since a new MCS table is generally designed in consideration of the small cell environment, a good channel environment may be assumed. Therefore, it is preferable to remove low MCS indexes corresponding to QPSK from the existing MCS table. However, since the channel environment may be suddenly worse, it is necessary to design MCS tables in preparation for the change in the channel environment. Method 1 for this is as follows.

Method 1: in order to ensure the performance of Radio Resource Control (RRC)/Voice over Internet Protocol (VoIP) as in the existing MCS table, TBS #0 may be maintained. To this end, MCS #0 should be maintained in the existing MCS table.

Next, since a correlation between a CQI table and an MCS table is high, it is preferable to design an MCS table in consideration of the correlation. For example, a method may be considered in which CQI entries #1, #3 and #5 or CQI entries #2, #4 and #6 are removed so as to advantageously maintain the uniform SNR gap between CQI entries. Method 2 for this is as follows.

Method 2: when removing low MCS indexes corresponding to QPSK, Method 2 may remove MCS entries every other MCS entry without removing consecutive MCS entries.

In addition, if there is a need for other MCS entries that should be removed in adding eight 256QAM entries, the following Method 3 may be considered in consideration of the small cell environment where a new MCS table has the frequency-flat channel characteristics.

Method 3: MCS entries may be removed from among the duplicate MCS entries (e.g., MCS indexes #9, #10, #16 and #17), which are generated with the same efficiency value for different modulation factors.

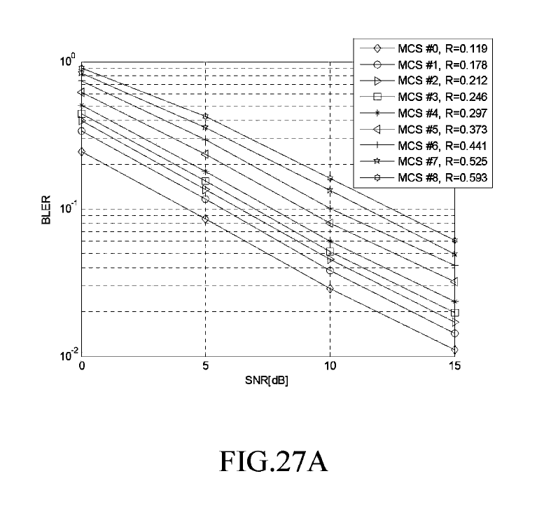

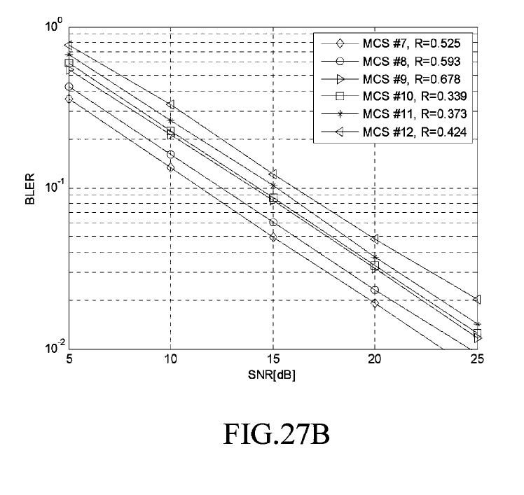

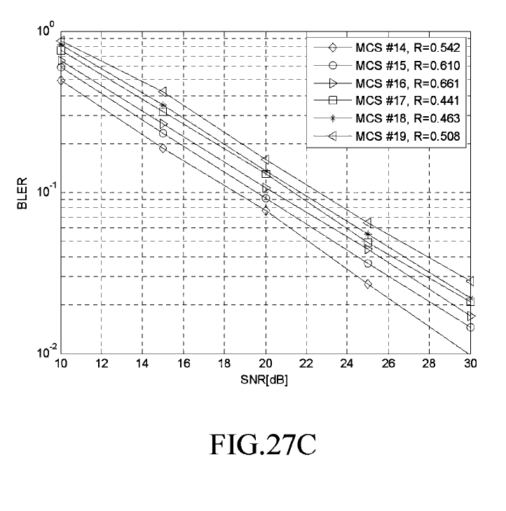

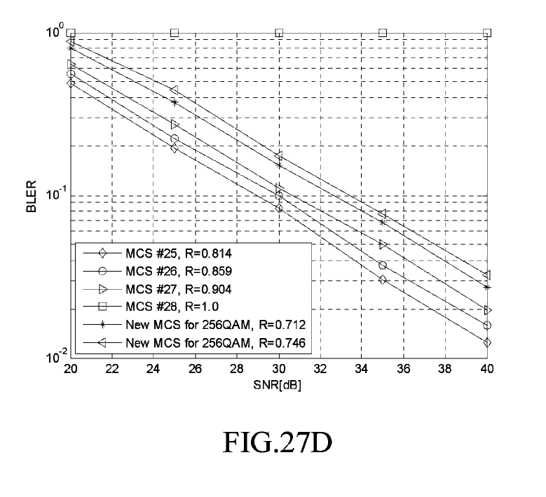

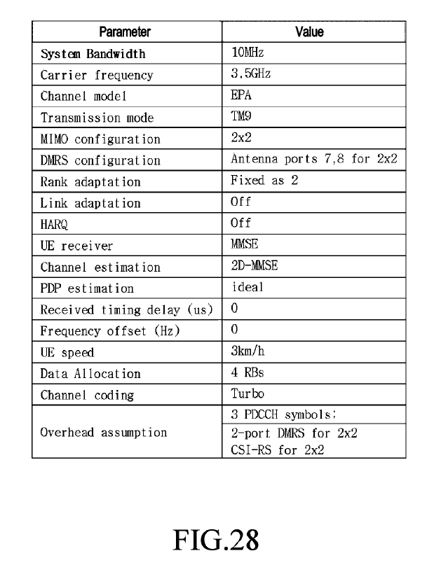

In order to make a more accurate and logical decision with respect to the proposed method(s), reference will be made to the experimental results in FIGS. 27A to 27D. This experiment was conducted in consideration of the small cell environment, and for the specific experimental environment, reference may be made to FIG. 28.

FIGS. 27A, 27B, 27C, 27D, and 28 illustrate the experimental results using an MCS table generated according to various embodiments of the present disclosure.

Referring to FIG. 28, the parameters (e.g., system bandwidth, carrier frequency, channel model, and the like) and their values used in the experiment are listed. Based on the experimental results in FIGS. 27A to 27D, it is possible to obtain the following observation results:

Observation result 1: it can be found from FIG. 27A that Method 2 makes it possible to maintain an SNR gap of about 2 dB between MCS entries in a low-SNR region.

Observation result 2: it can be found from FIGS. 27B and 27C that MCS #10 and MCS #17 corresponding to a high modulation factor among the duplicate MCS entries generated with the same efficiency value for different modulation factors show the Block Error Rate (BLER) performance which is duplicate with that of other MCS entities. Therefore, it is preferable to remove MCS #10 and MCS #17 by applying Method 3.

Observation result 3: it can be found from FIG. 27D that BLER of MCS #28 is 1. This is because as a result of rate matching, the code rate is 1. Actually, since CQI entry #15 corresponding to MCS #28 is removed even from the CQI table, it is preferable to remove MCS #28 from the MCS table.

Observation result 4: it can be found from FIG. 27D that if MCS #28 is removed, there is an SNR difference of 2 dB or more between MCS #27 and a new 256QAM entry, so it is preferable to maintain MCS #27 at interpolation points of 64QAM and 256QAM.

Based on the above observation results, the following MCS index removing method proposal is determined:

Proposal 1: MCS #0 may be maintained according to Method 1.

Proposal 2: when removing low MCS indexes corresponding to QPSK, this proposal may remove MCS entries every other MCS entry without removing consecutive MCS entries according to the observation result 2 above.

Proposal 3: this proposal may remove MCS #10 and MCS #17 corresponding to a high modulation factor among the duplicate MCS entries generated with the same efficiency value for different modulation factors according to the observation result 3 above.

Proposal 4: MCS #28 may be removed by the observation result 4 above.

Proposal 5: MCS #27 may be maintained according to the observation result 5 above.

According to the above proposals, MCS indexes #1, #3, #5, #7, #9, #10, #17 and #28 may be removed from the existing MCS table on the basis of the existing MCS table, and the explicit and implicit entries for 256QAM may be added. A table for this case is illustrated in FIG. 23. However, the MCS table generation method according to the present disclosure will not be limited only to the method of removing MCS indexes #1, #3, #5, #7, #9, #10, #17 and #28 based on the existing MCS table. For example, it is possible to maintain the MCS index #9 and additionally remove other MCS indexes based on the existing MCS table. In addition, it is possible to maintain all the MCS indexes #9, #10, #16 and #17 whose modulation schemes are changed, and to additionally remove other MCS indexes, in the existing MCS table.

In FIG. 23, TBS indexes #0˜#26 corresponding to MCS indexes are illustrated based on the existing MCS table. In addition, TBS indexes corresponding to newly added 256QAM entries are illustrated as TBS indexes #27˜#33 that are additional to the existing TBS indexes. However, if TBS indexes are newly defined in consideration of the MCS entries removed from the existing MCS table, the mapping between MCS indexes and TBS indexes may be newly defined as shown in FIG. 23.

As shown in FIG. 23, the MCS entries newly added for 256QAM support may be arranged in the size of the efficiency and defined as a new table, and the MCS entries for 256QAM may be added in positions of the MCS entries #1, #3, #5, #7, #9, #10, #17, and #28 removed from the existing MCS table as shown in FIG. 24, in consideration of the operation of the existing legacy terminal.

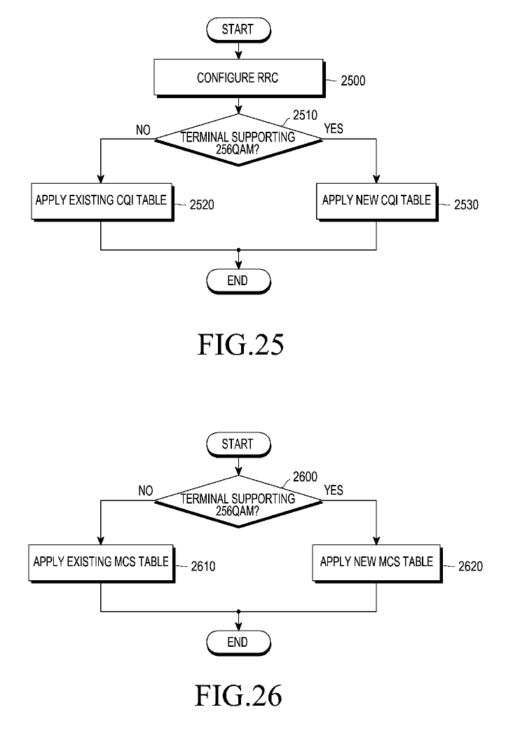

FIG. 25 is a flowchart illustrating how to use a CQI table according to an embodiment of the present disclosure.

Referring to FIG. 25, first, a BS may signal RRC to a terminal, considering whether to support 25QAM. The terminal may perform RRC configuration in operation 2500, and determine in operation 2510 whether the current terminal is a terminal supporting 256QAM. If the terminal is not a terminal supporting 256QAM, the terminal may feed the channel status back to the BS using the existing CQI table in operation 2520. On the other hand, if it is determined in operation 2510 that the current terminal is a terminal supporting 256QAM, the terminal may feed the channel status back to the BS using the new CQI table (e.g., tables in FIGS. 16, 17, and 19 to 22) according to an embodiment of the present disclosure, in operation 2530. A definition of the specific CQI table will follow the above-described embodiments.

FIG. 26 is a flowchart illustrating how to use an MCS table according to an embodiment of the present disclosure.

Referring to FIG. 26, first, a BS may determine in operation 2600 whether the current terminal supports 256QAM. If the current terminal does not support 256QAM, the BS may determine MCS by using the existing MCS table in operation 2610. However, if it is determined in operation 2600 that the current terminal supports 256QAM, the BS may determine MCS by using a new MCS table (e.g., tables in FIGS. 23 and 24) according to an embodiment of the present disclosure, in operation 2620. A definition of the specific CQI table will follow the above-described embodiments.

FIGS. 27A to 27D and FIG. 28 have been described when FIGS. 23 and 24 were described above, so further detailed description thereof will be omitted.

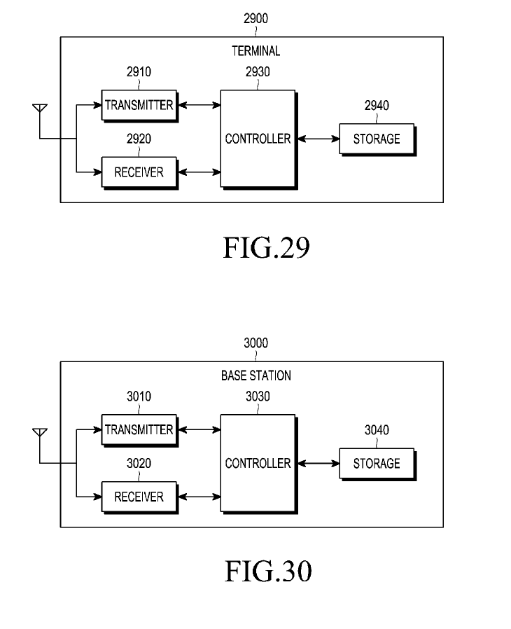

FIG. 29 illustrates a structure of a terminal according to an embodiment of the present disclosure.

A terminal 2900 may include a transmitter 2910, a receiver 2920, a controller 2930, and a storage 2940.

The transmitter 2910 and the receiver 2920 may include a transmission module and a reception module, respectively, for transmitting and receiving data to/from a BS in a communication system according to an embodiment of the present disclosure.

The controller 2930 may generate a CQI table according to the procedures described in FIGS. 16 to 24. A definition of the specific CQI table will follow the above-described embodiments (e.g., tables in FIGS. 16, 17, and 19 to 22).

The storage 2940 may store the information that is transmitted and received through the transmitter 2910 and the receiver 2920. In addition, the storage 2940 may store a variety of information generated in the controller 2930.

FIG. 30 illustrates a structure of a BS according to an embodiment of the present disclosure.

Referring to FIG. 30, a BS 3000 may include a transmitter 3010, a receiver 3020, a controller 3030, and a storage 3040.

The transmitter 3010 and the receiver 3020 may include a transmission module and a reception module, respectively, for transmitting and receiving data to/from a terminal in a communication system according to an embodiment of the present disclosure.

The controller 3030 may perform scheduling based on the channel status information (e.g., a CQI table) received from the terminal. In addition, the controller 3030 may determine MCS by using a new MCS table according to an embodiment of the present disclosure. A definition of the specific CQI table will follow the above-described embodiments (e.g., tables in FIGS. 23 and 24).

The storage 3040 may store the information that is transmitted and received through the transmitter 3010 and the receiver 3020. In addition, the storage 3040 may store a variety of information generated in the controller 3030.

It will be appreciated that the method and apparatus for generating control information in a wireless communication system according to an embodiment of the present disclosure may be implemented in the form of hardware, software, or a combination thereof. The software may be stored in a volatile or nonvolatile storage device (e.g., erasable/rewritable Read Only Memory (ROM)), a memory (e.g., Random Access Memory (RAM), memory chip, memory device, or memory Integrated Circuit (IC)), or an optically/magnetically recordable machine (e.g., computer)-readable storage medium (e.g., Compact Disc (CD), Digital Versatile Disc (DVD), magnetic disk, or magnetic tape). The method for generating control information in a wireless communication system according to an embodiment of the present disclosure may be implemented by a computer or a mobile terminal that includes a controller and a memory. It will be appreciated that the memory is an example of a non-transitory machine-readable storage medium suitable to store a program or programs including instructions for implementing various embodiments of the present disclosure.

Therefore, the present disclosure may include a program including a code for implementing the apparatus and method as set forth in any claims of the specification, and a non-transitory machine (or computer)-readable storage medium storing the program.

In addition, the apparatus for generating control information in a wireless communication system according to an embodiment of the present disclosure may receive the program from a program server to which the apparatus is connected by wire or wirelessly, and store the received program. The program server may include a memory for storing a program including instructions for performing the control information generation method in the wireless communication system, and storing information necessary for the control information generation method in the wireless communication system, a communication unit for performing wired/wireless communication with the control information generation apparatus, and a controller for transmitting the program to the control information generation apparatus automatically or at the request of the control information generation apparatus.

As is apparent from the foregoing description, the present disclosure may increase the system transmission efficiency by using CQI and MCS tables for supporting 256QAM in a wireless communication system.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for generating control information by a terminal in a wireless communication system, the method comprising:
determining whether the terminal supports a high-order modulation scheme; and
if the terminal supports the high-order modulation scheme, feeding back control information for supporting the high-order modulation scheme to a base station,
wherein the control information includes a first channel quality indicator (CQI) table for supporting the high-order modulation scheme, and
wherein the first CQI table is generated by removing a plurality of CQI entries from a second CQI table including a low-order modulation scheme, and replacing a last CQI table index as the high-order modulation scheme.

2. The method of claim 1, wherein the high-order modulation scheme includes 256-ary quadrature amplitude modulation (QAM) and the low-order modulation scheme includes at least one of quadrature phase shift keying (QPSK), 16QAM, or 64QAM.

3. The method of claim 2, wherein the first CQI table is generated by maintaining a substantially uniform signal to noise ratio (SNR) gap between entries of the first CQI table.

4. The method of claim 2,
wherein a CQI index #0 is maintained as out-of-range in the first CQI table, and
wherein a CQI table index including the high-order modulation scheme is arranged in the first CQI table according to a spectral efficiency.

5. The method of claim 2, further comprising configuring radio resource control (RRC).

6. A method for generating control information by a base station in a wireless communication system, the method comprising:
determining a first modulation and coding scheme (MCS) table based on a channel status,
wherein the first MCS table is generated by removing a plurality of MCS entries related to a low-order modulation scheme from a second MCS table, and setting a last MCS table index as a retransmission mode for a high-order modulation scheme.

7. The method of claim 6, wherein the high-order modulation scheme includes 256-ary quadrature amplitude modulation (QAM) and the low-order modulation scheme includes at least one of quadrature phase shift keying (QPSK), 16QAM, or 64QAM.

8. The method of claim 7, wherein a value of an MCS index #0 in the first MCS table and a value of an MCS index #0 in the second MCS table are the same.

9. The method of claim 7, wherein, in a case where an MCS index corresponding to the QPSK is removed, the first MCS table is generated by removing alternating MCS entries without removing consecutive MCS entries.

10. The method of claim 7, wherein the first MCS table is generated by removing duplicate MCS entries that are generated with a same efficiency value for different modulation factors.

11. An apparatus for generating control information in a terminal for a wireless communication system, the apparatus comprising:
a controller configured to determine whether the terminal supports a high-order modulation scheme, and to, if the terminal supports the high-order modulation scheme, feed back control information for supporting the high-order modulation scheme to a base station,
wherein the control information includes a first channel quality indicator (CQI) table for supporting the high-order modulation scheme, and
wherein the first CQI table is generated by removing a plurality of CQI entries from a second CQI table including a low-order modulation scheme and replacing a last CQI table index as the high-order modulation scheme.

12. The apparatus of claim 11, wherein the high-order modulation scheme includes 256-ary quadrature amplitude modulation (QAM) and the low-order modulation scheme includes at least one of quadrature phase shift keying (QPSK), 16QAM, or 64QAM.

13. The apparatus of claim 12, wherein the first CQI table is generated by maintaining a substantially uniform signal to noise ratio (SNR) gap between entries of the first CQI table.

14. The apparatus of claim 12,
wherein a CQI index #0 is maintained as out-of-range in the first CQI table, and
wherein a CQI table index including the high-order modulation scheme is arranged in the first CQI table according to a spectral efficiency.

15. The apparatus of claim 12, wherein the controller is configured to configure radio resource control (RRC).

16. An apparatus for generating control information in a base station for a wireless communication system, the apparatus comprising:
a controller configured to determine a first modulation and coding scheme (MCS) table based on a channel status,
wherein the first MCS table is generated by removing a plurality of MCS entries related to a low-order modulation scheme from a second MCS table, and setting a last MCS table index as a retransmission mode for a high-order modulation scheme.

17. The apparatus of claim 16,
wherein the high-order modulation scheme includes 256-ary quadrature amplitude modulation (QAM), and
wherein the low-order modulation scheme includes at least one of quadrature phase shift keying (QPSK), 16QAM, or 64QAM.

18. The apparatus of claim 17, wherein a value of an MCS index #0 in the first MCS table and a value of an MCS index #0 in the second MCS table are the same.

19. The apparatus of claim 17, wherein, in a case where an MCS index corresponding to the QPSK is removed, the first MCS table is generated by removing alternate MCS entries without removing consecutive MCS entries.

20. The apparatus of claim 17, wherein the first MCS table is generated by removing duplicate MCS entries that are generated with a same efficiency value for different modulation factors.
